(19) United States
(12) Patent Application Publication
(10) Pub. No.: US 2026/0246741 A1
(43) Pub. Date: Aug. 20, 2026

(54) Managing Resource Usage in a Radio Access Network

(71) Applicant: Telefonaktiebolaget LM Ericsson (publ), Stockholm (SE)

(72) Inventors: Kurt Essigmann, Aachen (DE); Klaus Turina, Herzogenrath (DE)

(21) Appl. No.: 19/161,791

(22) PCT Filed: Mar. 9, 2023
(86) PCT No.: PCT/IB2023/052264

§ 371 Date: Sep. 3, 2025

(51) Int. Cl. H04L 47/2475; H04W 24/02; H04W 28/02

(52) U.S. Cl. CPC H04L 47/2475; H04W 24/02; H04W 28/0268

(57) ABSTRACT

According to an aspect, there is provided a computer-implemented method of managing resource usage in a radio access network, RAN, of a communication network. One or more user equipments, UEs, are to communicate using the RAN. The method comprises: receiving (701) a traffic profile for traffic for the one or more UEs, wherein the traffic profile is received via application layer communications from a UE and/or a server that is connected to the communication network, wherein the traffic profile relates to requirements for one or more Quality of Service, QoS, flows for the one or more UEs; monitoring (703) performance of one or more cells in the RAN; determining (705), based on the monitored performance and the received traffic profile, changes to the connectivity of one or more UEs to the RAN and/or changes to one or more QoS flows; and sending (707) control signals to the RAN to effect the determined changes.

### TECHNICAL FIELD

This disclosure relates to managing resource usage in a radio access network (RAN) of a communication network.

### BACKGROUND

Today there is an established ecosystem of industrial (non 3^{rd} Generation Partnership Project (3GPP)) consortia and standardisation organisations where industrial applications such as automation, logistics, processing, etc. are specified, and related protocols and parameters are defined. One such organisation is the OPC Foundation. These industrial applications communicate according to these specifications. For the industry automation ecosystem, communication via 3GPP New Radio (NR) is just one of many enabling technologies comparable to wired Ethernet, WiFi, Bluetooth or WirelessHeart. Thus 3GPP is just another communication system that Industrial Internet of Things (IIOT) applications (APPs) may choose to use within the enterprise IT domain. In that respect the 3GPP system should interwork with the IIoT APP in terms of interfaces, both for the user plane as well as for signalling of the needed Quality of Service (QoS) parameters.

In current solutions, the IIoT APP does not signal any QoS parameters to the 3GPP system, but static subscription-based QoS parameters are applied. On the one hand that allows traffic differentiation between different User Equipments (UEs), but on the other hand the criticality between different IIoT APPs using either different UEs or different QoS flows within a UE cannot be differentiated.

In current industry deployments there is no possibility for the 3GPP Radio Access Network (RAN) to get (receive) detailed information about the needs of the IIoT application. The possibilities today are that the Core Network Functions (NFs) make assumptions about the needs of the application, for example based on subscription attributes or by traffic analysis, and map these to the set of 3GPP-defined 5th Generation (5G) QoS Index (5QI) parameters. These are then used towards the RAN to establish, modify and monitor the QoS flows. This means a lot of detailed and valuable information that would be useful for optimised RAN resource scheduling cannot be made available to RAN nodes.

FIG. 1 illustrates the nodes/units present in an existing 3GPP system that can be used by an IIoT APP. A user equipment (UE) 102 can run or execute an IIoT APP 104. The UE 102 connects to a RAN 105 of the 3GPP network via a Distributed Unit (DU) 106. The DU 106 is connected to a Centralised Unit (CU) 108, and the CU 108 is connected to one or more NFs 110 in the Core Network (CN). The Core NFs 110 are connected to the Enterprise IT Domain 112, which runs or executes an IIoT APP 114. As noted above, the Core NFs 110 make assumptions about the needs of the application, for example based on subscription attributes or by traffic analysis, and map these to the set of 5QI parameters. The Core NFs 110 apply subscription-based QoS profiles to the IIoT APP 114.

### SUMMARY

Scarce RAN resources (spectrum) is today shared between all UEs based on the 5QI values and some precedence values provided by the core network (CN) to the Radio Access Network (RAN). However, when the resource usage is critically high, the traffic of all UEs may be degraded as the RAN nodes have no knowledge about the application criticality and priority. In such cases (i.e. cases where the time-critical and/or mission-critical services may fail) the resources must be made available for UEs carrying communications only when that UE really is executing time-critical and/or mission-critical services.

At the same time, a device (UE) can serve multiple use cases via several QoS flows. The RAN does not know the criticality of the QoS flow(s) of the devices and cannot optimally use/schedule radio resources. In addition, the core network lacks that detailed information and cannot provide it to the RAN either. As a result, either resources will be wasted due to unnecessary resource reservation, or too few resources are allocated to highly prioritised QoS flows, and those flows fail to comply to the expectations of the application(s).

The techniques described herein provide for a UE, a server (or other type of computer) connected to the network, or an industrial application (the IIoT APP) running on a UE or the server/computer to send its traffic profile (in the industrial definition) to a RAN resource management node, optionally in addition to the optional 5QI value chosen at QoS flow setup. Thus, this traffic profile is sent to the RAN resource management node via application layer communications.

Based on that received (industrial) traffic profile, the RAN resource management node can manage radio resources in an optimised, or more optimised, manner. An application/UE/server can update the profile dynamically and request the service characteristics it really needs at a given time.

The RAN resource management node can instruct or command the RAN to prioritise radio resources between one or more UEs under its control. For example, UEs can be moved to cells with more radio resources (e.g. mmWave cells), certain QoS flows of one or more UEs can be moved to another cell, QoS flows can be downgraded and the respective application can be informed, one or more new QoS flows can be added, or low-priority QoS flows of UEs or the UE itself can be released to free up resources for high-priority flows/UEs.

With the techniques described herein, in case of scarce and/or congested radio resources, the RAN resource management node in the 5G/6th Generation (6G) network can take (better) decisions which QoS flows and UE(s) should be prioritised.

UEs/servers/IIoT APPs can send their native traffic profiles to the RAN resource management node so that the level of detail available about the traffic (e.g. traffic generated/used by the application (“application traffic”) is at a higher granularity as compared to the 5QI. UEs/servers/IIoT APPs can also dynamically modify the profiles, enabling the RAN resource management node to provide a dynamic and optimised radio resource utilisation.

According to a first aspect, there is provided a computer-implemented method of managing resource usage in a RAN of a communication network. One or more UEs are to communicate using the RAN. The method comprises: receiving a traffic profile for traffic for the one or more UEs via application layer communications from a UE and/or a server that is connected to the communication network. The traffic profile relates to requirements for one or more QoS flows for the one or more UEs. The method also comprises monitoring performance of one or more cells in the RAN; determining, based on the monitored performance and the received traffic profile, changes to the connectivity of one or more UEs to the RAN and/or changes to one or more QoS flows; and sending control signals to the RAN to effect the determined changes.

According to a second aspect, there is provided a computer program product comprising a computer readable medium having computer readable code embodied therein, the computer readable code being configured such that, on execution by a suitable computer or processor, the computer or processor is caused to perform the method according to the first aspect or any embodiment thereof.

According to a third aspect, there is provided a RAN resource management node configured to manage resource usage in a RAN of a communication network. One or more UEs are to communicate using the RAN. The RAN resource management node is configured to receive a traffic profile for traffic for the one or more UEs via application layer communications from a UE and/or a server that is connected to the communication network. The traffic profile relates to requirements for one or more QoS flows for the one or more UEs. The RAN resource management node is also configured to monitor performance of one or more cells in the RAN; determine, based on the monitored performance and the received traffic profile, changes to the connectivity of one or more UEs to the RAN and/or changes to one or more QoS flows; and send control signals to the RAN to effect the determined changes.

According to a fourth aspect, there is provided a RAN resource management node comprising a processor and a memory for managing resource usage in a RAN of a communication network. One or more UEs are to communicate using the RAN. The memory contains instructions executable by said processor whereby said RAN resource management node is operative to receive a traffic profile for traffic for the one or more UEs via application layer communications from a UE and/or a server that is connected to the communication network. The traffic profile relates to requirements for one or more QoS flows for the one or more UEs. The RAN resource management node is also operative to monitor performance of one or more cells in the RAN; determine, based on the monitored performance and the received traffic profile, changes to the connectivity of one or more UEs to the RAN and/or changes to one or more QoS flows; and send control signals to the RAN to effect the determined changes.

### BRIEF DESCRIPTION OF THE DRAWINGS

Some of the embodiments contemplated herein will now be described more fully with reference to the accompanying drawings, in which:

FIG. 1 illustrates the nodes/units present in an existing 3GPP system that can be used by an IIoT application;

FIG. 2 illustrates an implementation of the techniques described herein in a 3GPP system;

FIG. 3 is a signalling diagram illustrating signalling in the system when a traffic profile is received or updated;

FIG. 4 is a flow chart illustrating a method of operating a RAN resource management node when a traffic profile is received or updated;

FIG. 5 is a signalling diagram illustrating signalling in the system when new performance data for a cell is received;

FIG. 6 is a flow chart illustrating a method of operating a RAN resource management node when new performance data for a cell is received;

FIG. 7 is a flow chart illustrating a method of managing resource usage in a RAN according to the techniques described herein;

FIG. 8 is a block diagram of a RAN resource management node in accordance with some embodiments; and

FIG. 9 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

As noted above, a RAN resource management node is provided that receives a traffic profile for one or more UEs via application layer communications, and based on that traffic profile and the performance of one or more cells in the network, the RAN resource management node can manage radio resources in an optimised, or more optimised, manner. While the RAN resource management node is described with reference to an industrial IoT scenario using a non-public/private network, it will be appreciated that the RAN resource management node can be used in a public network (e.g. a public land mobile network (PLMN)), a slice of a public network, a terrestrial network, or a non-terrestrial network. In addition, use of the RAN resource management node is not limited to industrial IoT scenarios, and those skilled in the art will be aware of other scenarios in which the RAN resource management node can be used.

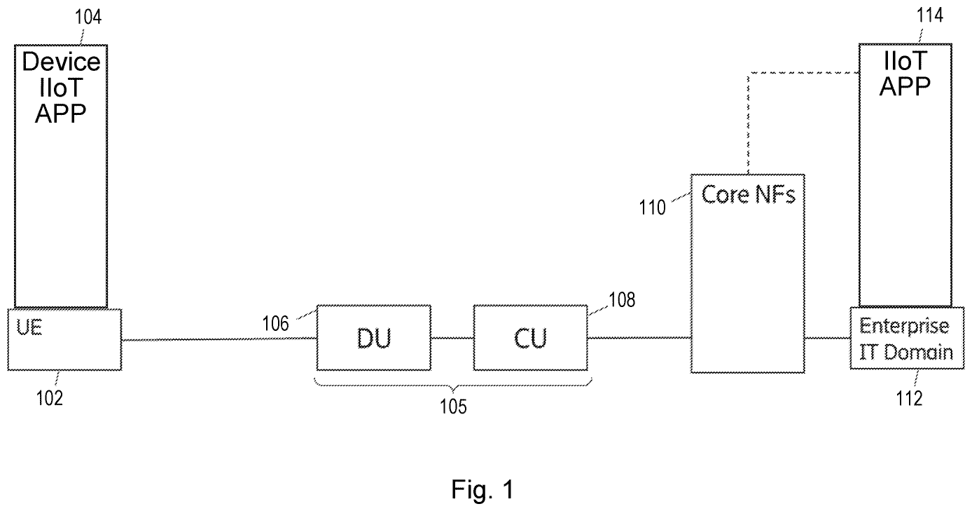

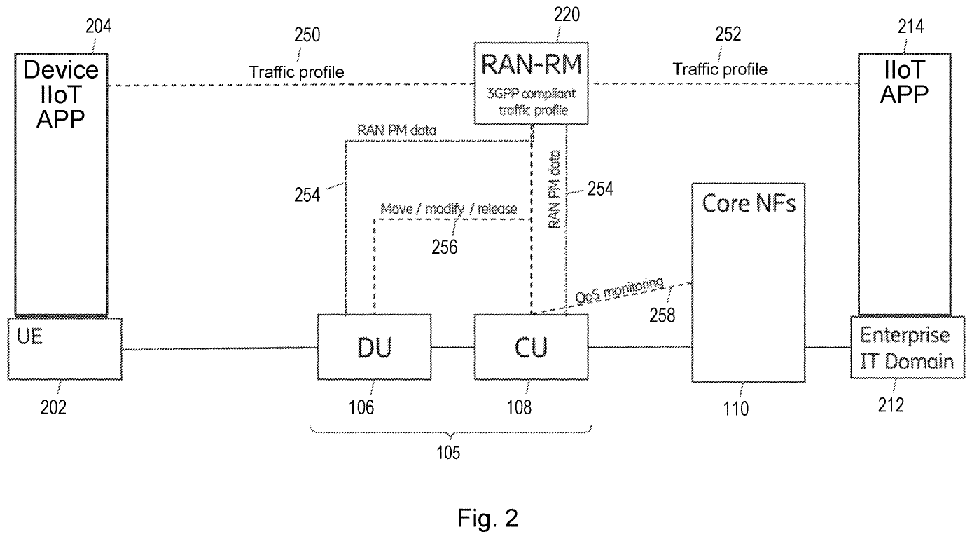

FIG. 2 shows an exemplary implementation of a RAN resource management node in a 3GPP system (and in particular a 5G NR system). The 3GPP system architecture in FIG. 2 is similar to that shown in FIG. 1, and the same components/nodes/entities in FIGS. 1 and 2 are given the same reference numerals. Thus, one or more UEs 202 can run or execute an IIoT APP 204. The UE 202 connects to a RAN 105 of the 3GPP network, with the RAN 105 comprising one or more DUs 106, which are connected to one or more CUs 108. The CU 108 is connected to one or more NFs 110 in the CN.

In the embodiment illustrated in FIG. 2, an Enterprise IT Domain 212 (which is referred to generally as “server 212”) is connected to the Core NFs 110, and the server 212 can also run or execute an IIoT APP 214. The server 212 is external to the Core NFs 110, and can be external to the communication network itself. In this illustrated embodiment, the UE(s) 202 can communicate with the server 212, or more specifically the IIoT application 204 running on the UE(s) 202 can communicate with the IIoT application 214 running on the server 212. Thus, communications between the UE(s) 202 and the server 214 are via the RAN 105 and relevant Core NFs 110.

In an alternative embodiment to that illustrated in FIG. 2, the Enterprise IT Domain/server 212—which runs or executes an IIoT APP 214—can be provided with wireless communication means to enable the server 212 to access, and communicate via, the RAN 105. In this case the server 212 is effectively another UE 202. In this embodiment, the UE(s) 202 can communicate with each other and/or with the server 212 (or more specifically the IIoT application 204 running on the UE(s) 202 can communicate with the IIoT application 204 running on another UE 202 or the IIoT application 214 running on the server 212). Thus, communications between the UE(s) 202 and/or communications between the other UE(s) 202 and the server 214 are via the RAN 105, and relevant Core NFs 110.

In another alternative embodiment to that illustrated in FIG. 2, there is no Enterprise IT Domain/server 212 running or executing IIoT APP 214. In this embodiment, the UE(s) 202 can communicate with each other (or more specifically the IIoT application 204 running on the UE(s) 202 can communicate with the IIoT application 204 running on another UE 202. Thus, communications between the UE(s) 202 are via the RAN 105, and relevant Core NFs 110.

In FIG. 2 a RAN resource management node 220 is shown that is able to interact with the UE(s) 202 and/or the server 212 (if present), and the RAN 105 (i.e. in this embodiment the DU 106 and/or CU 108). The RAN resource management node 220 is for managing resource usage in the RAN 105 based on a traffic profile(s) received from the UE(s) 202 and/or the server 212.

The traffic profile may relate to traffic or traffic requirements between the UE(s) 202 and the server 212. In addition or alternatively, the traffic profile may relate to traffic or traffic requirements between different UEs 202, and in particular traffic that is sent between the UEs 202 via the RAN 105.

While the IIoT app(s) 204 and/or 214 are described herein as being responsible for managing and sending the traffic profiles to the RAN resource management node 220, it will be appreciated that the UE(s) 202 and/or the server 212 can themselves be configured (e.g. in terms of hardware, firmware, software or the underlying operating system) to manage and send the traffic profiles to the RAN resource management node 220, and a separate or distinct IIoT app is not required.

While FIG. 2 and the following description of the operations of the RAN resource management node 220 refer to the RAN 105 comprising one or more CUs 108 and one or more DUs 106, it will be appreciated that the RAN resource management node 220 can be used with a RAN 105 that does not use a distributed RAN architecture, and in those embodiments the RAN resource management node 220 can communicate with base stations, such as eNBs and/or gNBs, rather than DUs 106 and CUs 108. In other embodiments, the RAN resource management node 220 is able to communicate with units in a distributed RAN architecture, and regular (non-distributed) base stations.

As used herein, a UE 202 includes or refers to a device capable, configured, arranged and/or operable to communicate wirelessly with nodes in the RAN 105, other UEs 202 and/or with the server 212 via the RAN 105 and the CN 110. Examples of a wireless device/UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A wireless device/UE 202 may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE 202 may not necessarily have a user in the sense of a human user who owns and/or operates the relevant device. Instead, a UE 202 may represent a device that is intended for sale to, or operation by, a human user but which may not, or which may not initially, be associated with a specific human user (e.g. a smart sprinkler controller or a smart sensor to be used to monitor machinery in a factory). Alternatively, a UE 202 may represent a device that is not intended for sale to, or operation by, an end user but which may be associated with or operated for the benefit of a user (e.g. a smart power meter).

A UE 202, when in the form of an IoT device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device can comprise circuitry and/or software in dependence on the intended application of the IoT device in addition to other components typically found in a UE 202 to enable the UE 202 to communicate with the RAN 105.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

The RAN 105, and specifically the base stations and/or DUs 106 in the RAN 105, facilitate direct or indirect connection of UEs 202 via one or more wireless connections. As used herein, a base station or DU refers to equipment capable, configured, arranged and/or operable to communicate directly or indirectly with a UE and/or with other network nodes or equipment, in a telecommunication network. Examples of base stations include, but are not limited to, access points (APs), Node Bs, evolved Node Bs (eNBs) and NR NodeBs (gNBs).

The server 212 may be under the ownership or control of an entity other than an operator or provider of the RAN 105 and/or Core NFs 110. The server 212 may host a variety of applications to provide one or more services, including the IIoT application 214. The server 212 may be located remotely from the RAN 105 and/or Core NFs 110. Alternatively, for example in an IIoT implementation where the RAN 105 and Core NFs 110 are part of a non-public/private network provided for an industrial environment, the server 212 may be in the same location or premises as the RAN 105 and/or Core NFs 110.

Returning to FIG. 2, the new entity, the RAN resource management node 220 (also referred to as RAN Resource Manager (RAN-RM) 220) receives the (IIoT) traffic profile from one or more of the Industrial IoT Applications 204, 214. As noted, the IIoT application may reside either on a UE 202, for example as an embedded software (SW) entity, or the IIoT application may reside on server 212 in the enterprise IT domain. In either case, the communication with the RAN-RM 220 is non-real time, and can use any established communication path in the application layer. For example, the communication path can be a default Protocol Data Unit (PDU) session if the traffic profile resides in a UE 202, or the communication path can be an Internet Protocol (IP) connection if the traffic profile resides in the server 212.

The functions/operations performed by the RAN-RM 220 can include any of:
1) Storing and analysing the traffic profile of one or more (or all) UEs 202. It can be that non-supported profile attribute values are rejected toward the IIoT APP 204, 214 that provided the traffic profile.
2) Collecting, e.g. on a regular basis, performance data from one or more (or all) cells in the communication network, and/or performance data from one or more (or all) DUs 106. This performance data can be analysed, and for example the RAN-RM 220 can calculate a parameter representing the cell load, which is referred to herein as Weighted Cell Load (WCL). The RAN-RM 220 can also receive events, or information about events, from the CU 108 relating to establishment, modification and/or release of QoS flows.
3) When new or modified traffic profiles are received, and/or when new WCLs are calculated, a resource analysis algorithm is triggered and evaluated by the RAN-RM 220. That algorithm decides if:
   a. certain QoS flows, respectively Data Radio Bearers (DRB) need to be moved to other cells; or
   b. if UEs need to be moved to different cells, or
   c. if lower-priority QoS flows or lower-priority UEs have to be disconnected. In this case, the RAN-RM 220 may inform the relevant IIoT APP 204, 214 or node (UE 202 or server 212) of this disconnection.

As noted, the IIoT APP 204/214 sends the traffic profile(s) to the RAN-RM 220 via application layer communications. A traffic profile relates to requirements for one or more QoS flows for the UE(s) 202. The traffic profile can be provided by the UE(s) via an application layer traffic profile interface 250 in FIG. 2, and/or provided from the server 212 via an application layer traffic profile interface 252.

The RAN-RM 220 also has interfaces 254 for receiving performance (PM) data from the RAN 105, e.g. from the DU(s) 106 and the CU 108. The RAN-RM 220 also has an interface 256 with the RAN 105, e.g. with the DU(s) 106 and/or CU 108, that enables the RAN-RM 220 to send commands or instructions to the RAN 105 to move, modify, add, or release QoS flows or UEs.

The Core NFs 110 have a QoS monitoring interface 258 with the RAN 105, e.g. the CU 108, for receiving information about the QoS of existing QoS flows in the network.

In some embodiments, the traffic profiles can be non-deterministic. In alternative embodiments, the traffic profiles can be deterministic. Both types of traffic profile can comprise an indication of the criticality for the application of the relevant QoS flow, which the RAN-RM 220 uses to determine the importance and/or priority of a certain QoS flow compared to other QoS flows.

The traffic profiles can comprise further or other types of information relating to QoS flows and/or UEs 202.

In particular, a non-deterministic traffic profile can comprise an indication of any of:
a) a criticality of the QoS flow or traffic for a certain UE(s) (e.g. in terms of high, medium, low);
b) an average data throughput (kbit/s) in uplink (UL) and/or downlink (DL); and
c) a peak data throughput (kbit/s) in UL and DL.

A deterministic traffic profile can relate to UL, DL, or both, and can comprise an indication of any of:
a) a criticality of the QoS flow or traffic for a certain UE(s) (e.g. in terms of high, medium, low);
b) a periodicity type for the traffic for the QoS flow or traffic for a certain UE(s) (e.g. periodic, aperiodic);
c) a transfer interval of the QoS flow or traffic for a certain UE(s) (e.g. periodic (ms), aperiodic (ms));
d) an inactivity period for the traffic for the QoS flow or traffic for a certain UE(s) (e.g. time-stop, time-start);
e) a jitter tolerance (ms) for the QoS flow and/or certain UE(s);
f) a packet loss tolerance for the QoS flow and/or certain UE(s) (e.g. a number of accepted consecutive packets lost); and
g) a typical packet data size (byte).

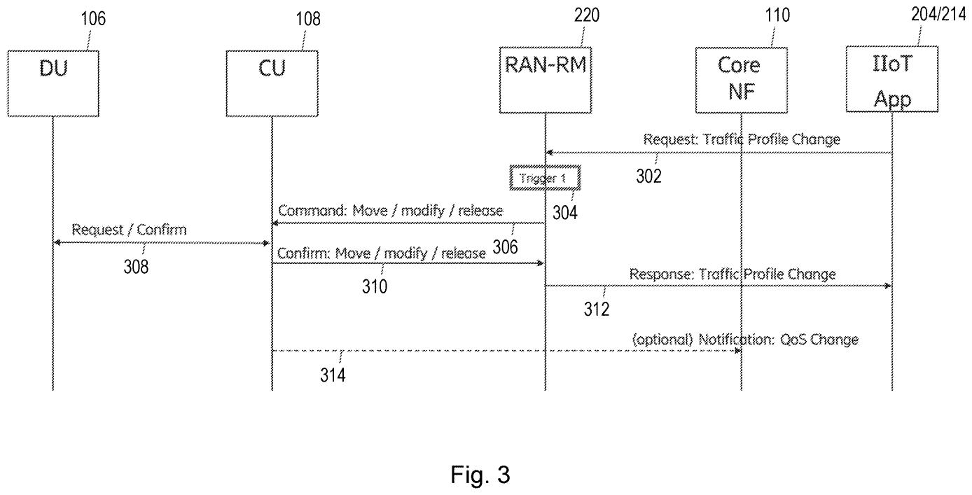

FIG. 3 is a signalling diagram illustrating signalling in the system of FIG. 2 when a traffic profile is received or updated. In particular, FIG. 3 shows the signalling between DU 106, CU 108, RAN-RM 220, Core NF 110 and an IIoT application 204/214.

Initially an IIoT application 204/214 (i.e. in a UE 202 or server 212) sends a request 302 to the RAN-RM 220 that requests or indicates that there is a new traffic profile for an existing or new QoS flow, or a change in the traffic profile for an existing QoS flow. This request 302 includes the new or changed traffic profile. As shown in FIG. 3, this message 302 can be the message: “Request: Traffic Profile Change”. A new traffic profile or updated traffic profile for an already existing QoS flow can comprise new or modified attribute values.

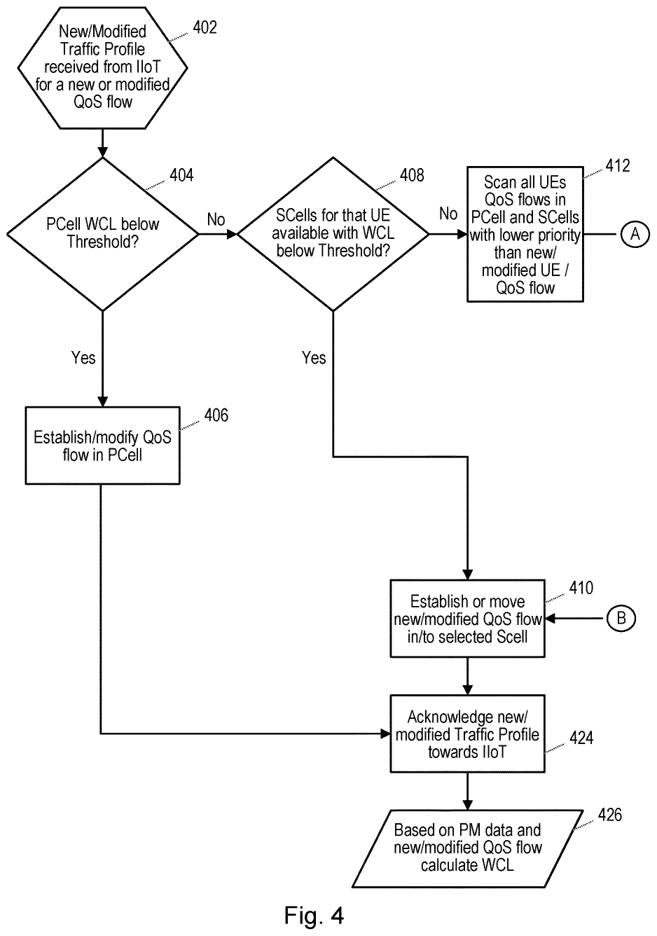

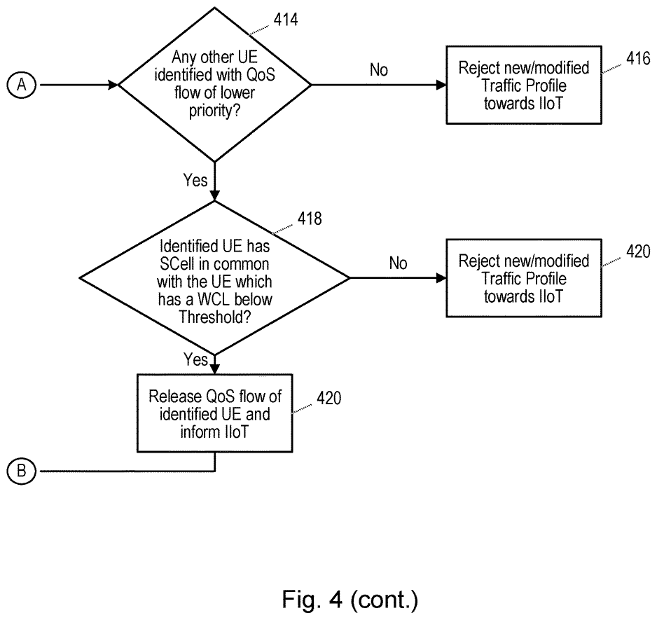

On receiving the new or changed traffic profile, the RAN-RM 220 is triggered to execute the RAN management algorithm (as indicated by step 304 ‘Trigger 1’). This algorithm is described in detail below with reference to FIG. 4.

That algorithm can result in a decision by the RAN-RM 220 to move, modify or release the QoS flow, add a new QoS flow, or move or release one or more UEs 202. To effect the decision by the algorithm, the RAN-RM 220 sends an instruction or command 306 to the CU 108 to instruct the CU 108 to add, move, modify or release QoS flows, or entire UEs. The instruction or command 306 to the CU 108 can be in any suitable format. One example of a suitable format is found in “O-RAN.WG2.A1TD-R003-v05.00”. In this Open-RAN (O-RAN) architecture example, the instruction or command 306 can be a http put/get interface with JavaScript Object Notation (JSON) objects. Provided below is the JSON object to steering traffic per UE:

Traffic steering per-UE

```
{
  “scope”: {
    “ueId”: “0000000000000855”
  },
  “tspResources”: [
    {
      “cellIdList”: [
        {“plmnId”: {“mcc”: “248”,“mnc”: “35”},
          “cId”: {“ncI”: 39}},
        {“plmnId”: {“mcc”: “248”,“mnc”: “35”},
          “cId”: {“ncI”: 40}}
      ],
      “preference”: “PREFER”
    },
    {
      “cellIdList”: [
        {“plmnId”: {“mcc”: “248”,“mnc”: “35”},
          “cId”: {“ncI”: 81}},
        {“plmnId”: {“mcc”: “248”,“mnc”: “35”},
          “cId”: {“ncI”: 82}},
        {“plmnId”: {“mcc”: “248”,“mnc”: “35”},
          “cId”: {“ncI”: 83}}
      ],
      “preference”: “FORBID”
    }
  ]
}
```

After sending the instruction or command 306 to the CU 108, the CU 108 subsequently requests the relevant DU(s) 106 to execute the changes. The DU(s) 106 confirm that the changes have been made to the CU 108. The request/confirm signalling between the DU 106 and CU 108 is shown in FIG. 3 by signal 308. The CU 108 confirms that command 306 has been completed by sending a confirmation 310 to the RAN-RM 220.

The RAN-RM 220 can then send a reply 312 to the IIoT Application 204/214 confirming that the traffic profile change has been effected. This reply 312 can be a new message: “Response: Traffic Profile Change”. This reply 312 can inform the IIoT Application 204/214 whether or not the requested new or changed traffic profile was fulfilled or rejected, or whether an alternative traffic profile was applied. In the latter case the IIoT Application 204/214 may accept the alternative profile, or it may request an alternative traffic profile be applied.

Depending on the change to the QoS flow effected by the CU 108, the CU 108 may send a notification 314 to the Core NF 110 indicating that a QoS change has been made for a particular QoS flow.

FIG. 4 is a flow chart illustrating a method of operating a RAN resource management node (RAN-RM) 220 when a traffic profile is received or updated. This method is an implementation of step 304 in FIG. 3, and includes aspects of signals 306 and 312.

In step 402 the new/modified traffic profile is received from the IIoT application 204/214. The new/modified traffic profile relates to a new or existing QoS flow.

In step 404, the RAN-RM 220 calculates a parameter referred to as the Weighted Cell Load (WCL) for a primary cell (PCell) from measurements of the cells in the network, and compares the WCL to a threshold representing a target WCL value for the PCell.

The WCL is a parameter that is calculated based on the resources requested by the traffic profiles for QoS flows and the current utilisation of the dimensioned resources. The WCL can be determined separately for uplink (UL) and downlink (DL) traffic directions per cell. The WCL values can be recalculated each time an event notification is received from the CU 108 or DU 106. The event can be the availability of new performance data (also referred to as “performance management data” or “PM data”) for the cells. Alternatively the event can be that a new UE is accepted for connection, or a QoS flow is to be established/modified/released in the respective cell of the network.

The WCL can be calculated as follows. The input parameters to the WCL calculation are:
Traffic Profile: profile type (deterministic or non-deterministic) and attributes;
Configuration data per cell: configuredCellThroughput (UL/DL);
Performance data received per cell: measuredCellThrougput (UL/DL).

A weighting factor w is calculated using:

$$w = \frac{{\sum }_{UE} IIoTtrafficProfile \cdot TrafficType = deterministic}{\begin{matrix}{\sum }_{UE} ( IIoTtrafficProfile \cdot TrafficType = deterministic ) + \\ {\sum }_{UE} ( IIoTtrafficProfile \cdot TrafficType = non - deterministic )\end{matrix}}$$

$$and the Weighted Cell Load is calculated using :$$

$$WCL ( UL ) = w \cdot \frac{measuredCellThroughput UL}{configuredCellThroughput UL}$$

$$and$$

$$WCL ( DL ) = w . \cdot \frac{measuredCellThroughput DL}{configuredCellThroughput DL}$$

At step 404, if the calculated WCL is below the threshold, then the method passes to step 406 in which no specific action needs to be taken, and the QoS flow can be set up or modified in the PCell according to the received traffic profile. The method then passes to step 424 which is described later.

If the WCL of the PCell is above the threshold, the method passes to step 408 in which the algorithm checks if there is other possibilities to satisfy the requested change in the traffic profile. In particular, it is checked whether a Secondary Cell (SCell) is available for Carrier Aggregation (CA) and spectrum is available in the SCells for the requested QoS flow. In step 408 the UE capabilities and load level (WCL) of any eligible SCells is checked and if the WCLs in the SCells is below a threshold, the method passes to step 410 in which the QoS flow setup/change is performed utilising the SCell(s).

In case it is determined in step 408 that there is no suitable SCell available (i.e. the WCL is above the threshold), the method passes to step 412 then all QoS flow allocations for all UEs can be scanned or evaluated to determine (step 414) if there are any QoS flows that have a lower priority than the QoS flow to be established or modified according to the received traffic profile.

If no QoS flow is found that has a lower priority, the method passes to step 416 in which the traffic profile received in step 402 is rejected, and the IIoT application 204/214 is notified by the RAN-RM 220 accordingly.

If in step 414 a UE is found that has a QoS flow that has a lower priority, then in step 418 it is determined whether the identified UE has an SCell in common with the UE that the new/modified traffic profile relates to. If not, the method passes to step 420 in which the traffic profile received in step 402 is rejected, and the IIoT application 204/214 is notified by the RAN-RM 220 accordingly.

If the identified UE does have an SCell in common with the UE that the new/modified traffic profile relates to, then in step 420 the QoS flow of that UE is to be released (e.g. by the RAN-RM 220 sending a suitable command or instruction to the CU 108). Then the method passes to step 410 in which the RAN-RM 220 sets up or changes the QoS flow utilising the identified SCell(s) (e.g. by sending a suitable command or instruction to the CU 108).

Then, in step 424, the RAN-RM 220 informs the IIoT application 204/214 (e.g. via signal 312) about the release of the QoS flow and the establishment or change of the higher-priority QoS flow that relates to the traffic profile received in step 402.

Finally, in step 426, based on measurements of the performance of the cells after reconfiguring the QoS flows, the WCL can be recalculated.

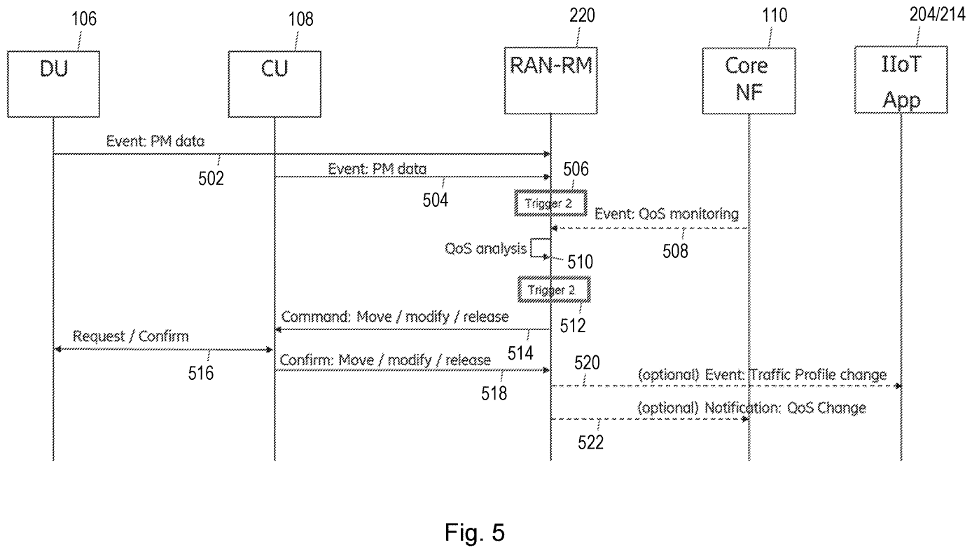

FIG. 5 is a signalling diagram illustrating signalling in the system when new performance (PM) data for a cell is received. In particular, FIG. 5 shows the signalling between DU 106, CU 108, RAN-RM 220, Core NF 110 and an IIoT application 204/214, similar to FIG. 3.

Initially, an event occurs in one or both of the DU 106 and CU 108. In particular, new performance data/measurements are available for one or more cells in the network. The DU 106 and/or CU 108 forward this PM data to the RAN-RM 220 via signals 502 and 504 respectively.

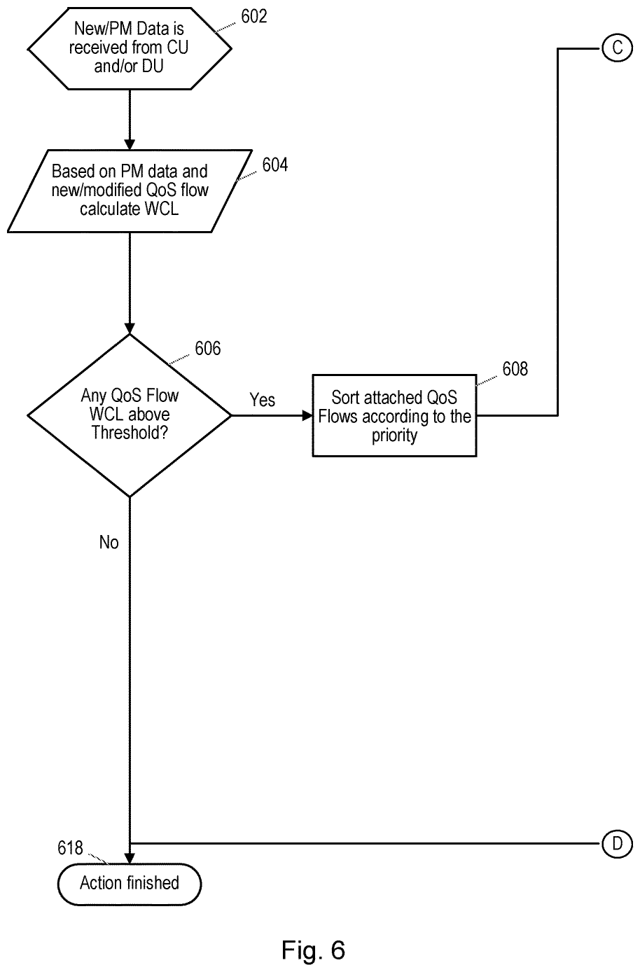

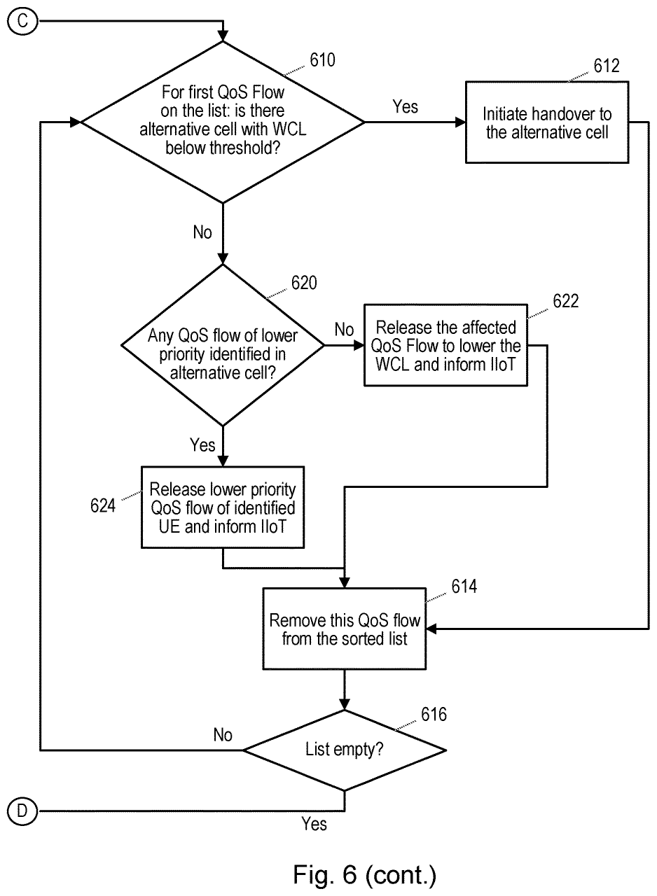

On receiving the new PM data, the RAN-RM 220 is triggered to execute the RAN management algorithm (as indicated by step 506 ‘Trigger 2’). This algorithm is described in detail below with reference to FIG. 6.

In addition or alternatively to the events represented by signals 502 and 504, QoS monitoring/measurements may be performed in the Core NF 110, and this QoS measurement data can be sent to the RAN-RM 220 via signal 508. The RAN-RM 220 can analyse the QoS data (step 510) and determine that the RAN management algorithm should be initiated (as indicated by step 512 ‘Trigger 2’). This algorithm is the same described in detail below with reference to FIG. 6.

That algorithm can result in a decision by the RAN-RM 220 to move, modify or release the QoS flow, add a new QoS flow, or move or release one or more UEs 202. To effect the decision by the algorithm, the RAN-RM 220 sends an instruction or command 514 to the CU 108 to instruct the CU 108 to add, move, modify or release QoS flows, or entire UEs. Subsequently the CU 108 requests the relevant DU(s) 106 execute the changes. The DU(s) 106 confirm that the changes have been made to the CU 108. The request/confirm signalling between the DU 106 and CU 108 is shown in FIG. 5 by signal 516. The CU 108 confirms that command 306 has been completed by sending a confirmation 518 to the RAN-RM 220.

The RAN-RM 220 can then send a reply 520 to the IIoT Application 204/214 confirming that the traffic profile change has been effected. This reply 520 can be a new message: “Response: Traffic Profile Change”. This reply 520 can inform the IIoT Application 204/214 whether or not the requested new or changed traffic profile was fulfilled or rejected, or whether an alternative traffic profile was applied. In the latter case the IIoT Application 204/214 may accept the alternative profile, or it may request an alternative traffic profile be applied.

Depending on the change to the QoS flow effected by the CU 108, the CU 108 may send a notification 522 to the Core NF 110 indicating that a QoS change has been made for a particular QoS flow.

FIG. 6 is a flow chart illustrating a method of operating a RAN resource management node when new performance data for a cell is received. This method is an implementation of steps 506 or 512 in FIG. 5, and includes aspects of signals 514 and 520.

In step 602 the new/changed PM data is received from the DU 106/CU 108.

In step 604, the RAN-RM 220 calculates the WCL for the cells from the PM data. The new WCL values are used to evaluate the current QoS flow allocations in the network.

In step 606 the calculated WCLs for the QoS flows are compared to a threshold representing a target WCL value.

If none of the QoS flow WCL values are above the threshold, then no further action is required.

However, in case any QoS flow WCL is above the threshold, then a priority decision is prepared by scanning and sorting all QoS flows above the threshold (i.e. in all cells where the threshold was exceeded) according to the priority attribute. In particular, at step 608, the QoS flows in cells where the WCL exceeds the threshold are sorted into a list according to the priority of the QoS flows.

Then, in step 610, for the first QoS flow in the list (i.e. the QoS flow with the highest priority), it is determined whether there is an alternative cell for that QoS flow where the WCL for that cell is below the threshold. If such a cell (i.e. a less-loaded cell) is available, the method moves to step 612 in which handover of the QoS flow to that cell is initiated (e.g. by the RAN-RM 220 sending a suitable command or instruction 514 to the CU 108).

Next, at step 614 the QoS flow with the highest priority in the list is removed from the sorted list. At step 616 it is determined if the list is empty (i.e. if all QoS flows have been evaluated). If the list is empty, the method ends at step 618.

If the list is not empty, the method returns to step 610 and operates on the highest priority QoS flow remaining in the sorted list.

If at step 610 there is no alternative cell with a WCL below the threshold, the method passes to step 620 where it is determined if there is any active QoS flow that has a lower priority in an alternative cell. If no lower priority QoS flow is found in step 620, then in step 622 it is determined that the QoS flow being evaluated is to be released (e.g. by the RAN-RM 220 sending a suitable command or instruction 514 to the CU 108). The RAN-RM 220 can also inform the IIoT application 204/214 (e.g. via signal 520) about the release of the QoS flow. The method passes to step 614 in which the evaluated QoS flow is removed from the sorted list.

However, if a lower priority QoS flow is found at step 620, then in step 624 it is determined that the lower priority QoS flow is to be released (e.g. by the RAN-RM 220 sending a suitable command or instruction 514 to the CU 108). The RAN-RM 220 can also inform the IIoT application 204/214 (e.g. via signal 520) about the release of the QoS flow. The method passes to step 614 in which the evaluated QoS flow is removed from the sorted list.

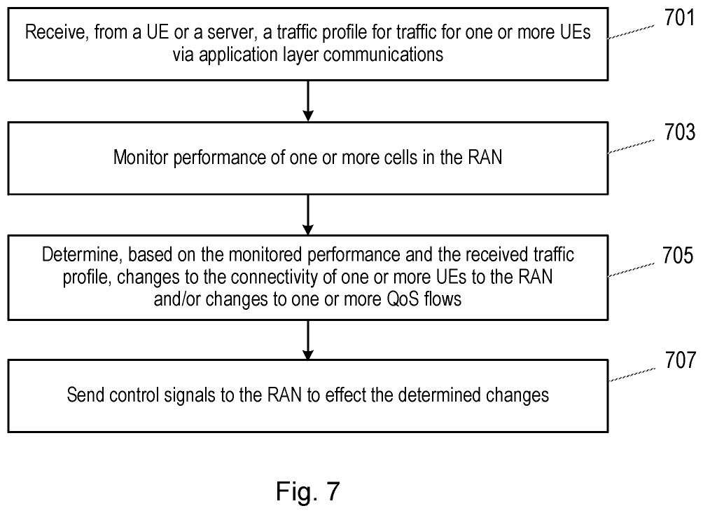

FIG. 7 is a flow chart illustrating a method of managing resource usage in a RAN according to the techniques described herein. The method may be performed by a RAN resource management node 220, for example in response to executing suitably formulated computer readable code. The computer readable code may be embodied or stored on a computer readable medium, such as a memory chip, optical disc, or other storage medium. The computer readable medium may be part of a computer program product.

In step 701, a traffic profile for traffic for one or more UEs 202 is received. The one or more UEs 202 are communicating using the RAN 105 (e.g. the UE(s) are in a connected or idle mode), or are to communicate using the RAN 105. The traffic profile can be received via application layer communications 250 from a UE 202. In this case the application layer communications 250 can be via a PDU session. In addition or alternatively, the traffic profile can be received via application layer communications 252 from a server 212 that is connected to the communication network. In this case the application layer communications 252 can be via an IP connection.

The traffic profile relates to requirements for one or more QoS flows for the one or more UEs 202. The traffic profile can relate to uplink traffic (i.e. from the UE(s) 202 to the server 212), downlink traffic (i.e. from the server 212 to the UE(s) 202), or both). The traffic profile does not need to relate to all established QoS flows and/or all UEs 202 connected to the RAN 105, and instead can relate to a subset of established QoS flows and/or a subset of UEs connected to the RAN 105. In some embodiments, a traffic profile may relate to a single QoS flow, or relate to a single UE 202, or a single type of UE 202 (e.g. a UE associated with a security camera, or a UE associated with a sensor for machinery, etc.).

In some embodiments, the traffic profile indicates an importance and/or priority of traffic in one or more QoS flows and/or traffic for one or more UEs. Importance and/or priority can be indicated in terms of a value, or level (e.g. ‘high’, ‘low’, etc.). Importance and/or priority may be indicated relative to an importance and/or priority of other QoS flow(s) and/or traffic for other UE(s).

The traffic profile may indicate any of the types of information described above.

In some embodiments, the traffic profile received in step 701 is an update to a previously received traffic profile.

In step 703, the performance of one or more cells in the RAN 105 is monitored. In some embodiments (particularly where the method is implemented by a RAN-RM 220), step 703 can comprise receiving performance monitoring data from the RAN 105. The performance of a cell can be monitored in terms of the data throughput for the cell.

In step 705, changes to the connectivity of one or more UEs 202 to the RAN 105 and/or to one or more QoS flows are determined based on the monitored performance and the received traffic profile(s). In step 705 the changes can be determined in order to meet or satisfy the traffic profile received in step 701.

The change(s) determined in step 705 can be any of: moving a QoS flow to a different cell in the RAN 105; modifying a QoS flow; releasing a QoS flow; adding a QoS flow; moving a UE 202 to a different cell in the RAN 105; releasing a UE 202 that is connected to the RAN 105; and releasing or disconnecting a QoS flow or UE 202 that has a lower priority than a QoS or UE 202 associated with the received traffic profile.

In some embodiments, the changes can be determined by calculating a load metric (e.g. the WCL) for a first cell from measurements representing performance of the first cell, comparing the calculated load metric to a target load metric for the first cell, and determining whether the received traffic profile can be satisfied in the first cell based on the comparison. In some embodiments, step 705 can be performed as set out in FIGS. 4 and/or 6, and/or as described above.

In a specific embodiment of step 705 where the first cell is a PCell, if the comparison indicates that the received traffic profile cannot be satisfied in the PCell, then step 705 can further comprise determining whether the received traffic profile can be satisfied in a SCell. If the traffic profile can be satisfied in a SCell, step 705 can comprise determining that the QoS flow(s) and/or UE(s) 202 should be moved to the SCell.

In another specific embodiment of step 705, if the comparison indicates that the received traffic profile cannot be satisfied in the first cell, it is determined whether one or more QoS flows and/or UEs 202 connected to the first cell have a lower priority than traffic according to the received traffic profile. If there are one or more QoS flows or UEs 202 connected to the first cell that have a lower priority, the step 705 can decide that these lower priority QoS flow(s) and/or UE(s) 202 should be moved from the cell, modified or released.

In step 707, control signals are sent to the RAN 105 to effect the determined changes. The control signals can be sent to any of a CU 108, one or more DUs 106 and one or more base stations.

In some embodiments, the method can further comprise notifying the UE(s) 202 and/or the server 212 of the changes to the connectivity of the UE(s) 202 to the RAN 105 and/or the changes to QoS flow(s).

In some embodiments, the communication network is a public communication network (e.g. a PLMN), a slice in a communication network, a private network, a non-public network (NPN), a terrestrial network or a non-terrestrial network.

In some embodiments, the UE(s) 202 and/or the server 212 are for performing an industrial application, for example an IIoT application. In this case, the UE(s) 202 can be considered to be IoT UE(s).

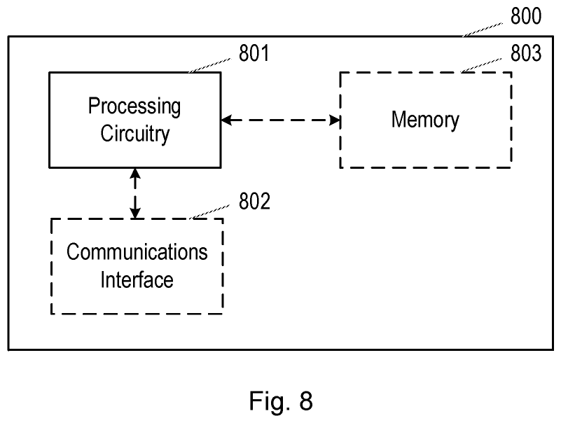

FIG. 8 is a simplified block diagram of a RAN resource management node 800 according to some embodiments that can be used to implement one or more of the techniques described herein.

The RAN resource management node 800 comprises processing circuitry (or logic) 801. It will be appreciated that the RAN resource management node 800 may comprise one or more virtual machines running different software and/or processes. The RAN resource management node 800 may therefore comprise, or be implemented in or as one or more servers, switches and/or storage devices and/or may comprise cloud computing infrastructure that runs the software and/or processes.

The processing circuitry 801 controls the operation of the RAN resource management node 800 to implement the relevant part of the methods described herein. The processing circuitry 801 can comprise one or more processors, processing units, multi-core processors or modules that are configured or programmed to control the exploration management function 800 in the manner described herein. In particular implementations, the processing circuitry 801 can comprise a plurality of software and/or hardware modules that are each configured to perform, or are for performing, individual or multiple steps of the method described herein in relation to the RAN resource management node 800.

The RAN resource management node 800 also comprises a communications interface 802. The communications interface 802 is for use in enabling communications with other network node, computers, servers, etc. For example, the communications interface 802 can be configured to transmit to and/or receive from other nodes (including the UEs 202, the server 212 and/or the RAN 105) requests, acknowledgements, information, data, signals, or similar. The communications interface 802 can use any suitable communication technology.

The processing circuitry 801 may be configured to control the communications interface 802 to transmit to and/or receive from other nodes, etc. requests, acknowledgements, information, data, signals, or similar, according to the methods described herein.

The RAN resource management node 800 may comprise a memory 803. In some embodiments, the memory 803 can be configured to store program code that can be executed by the processing circuitry 801 to perform the methods described herein in relation to the RAN resource management node 800. Alternatively or in addition, the memory 803 can be configured to store any requests, acknowledgements, information, data, signals, or similar that are described herein. The processing circuitry 801 may be configured to control the memory 803 to store such information therein.

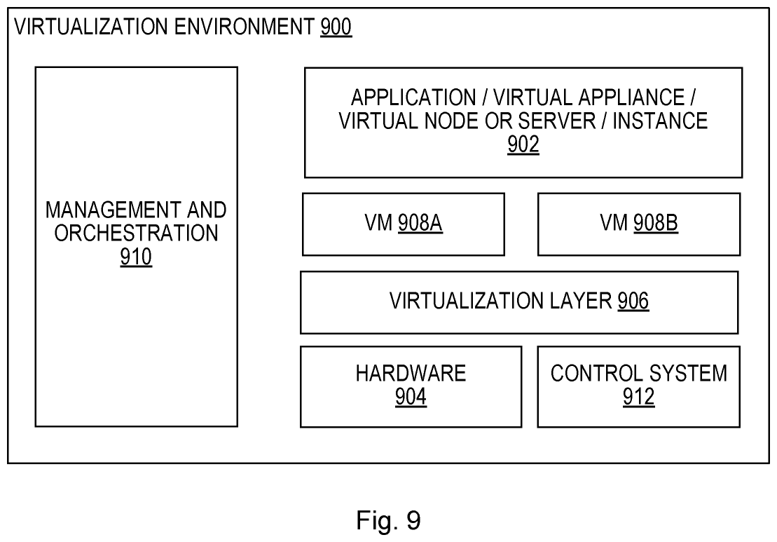

FIG. 9 is a block diagram illustrating a virtualization environment 900 in which functions implemented by some embodiments may be virtualized. For example, the RAN resource management node 220/800 described herein can be implemented in virtualization environment 900.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a RAN resource management node 220. Alternatively, the RAN resource management node 220 may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 912 which may alternatively be used for communication between hardware nodes and radio units.

Although the computing devices described herein (e.g. the RAN resource management node 220/800) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1.-58. (canceled)

59. A computer-implemented method of managing resource usage in a radio access network (RAN) of a communication network, wherein one or more user equipments (UEs) are to communicate using the RAN, the method comprising:
receiving a traffic profile for traffic for the one or more UEs, wherein the traffic profile is received via application layer communications from a UE and/or a server that is connected to the communication network, wherein the traffic profile relates to requirements for one or more Quality of Service, QoS, flows for the one or more UEs;
monitoring performance of one or more cells in the RAN;
determining, based on the monitored performance and the received traffic profile, changes to the connectivity of one or more UEs to the RAN and/or changes to one or more QoS flows; and
sending control signals to the RAN to effect the determined changes.

60. The method of claim 59, wherein the received traffic profile relates to one or both of uplink traffic and downlink traffic.

61. The method of claim 59, wherein the traffic profile relates to a subset of established QoS flows and/or a subset of the UEs connected to the RAN.

62. The method of claim 59, wherein the traffic profile indicates any one or more of:
a criticality of the traffic for the QoS flow and/or the one or more UEs;
an average data throughput on uplink and/or downlink for the traffic for the QoS flow and/or the one or more UEs;
a peak data throughput on uplink and/or downlink for the traffic for the QoS flow and/or the one or more UEs;
a periodicity type for the traffic for the QoS flow and/or the one or more UEs;
a transfer interval for the traffic for the QoS flow and/or the one or more UEs;
an inactivity period for the traffic for the QoS flow and/or the one or more UEs;
a jitter tolerance for the traffic for the QoS flow and/or the one or more UEs;
a packet loss tolerance for the traffic for the QoS flow and/or the one or more UEs; and
a typical packet data size for the traffic for the QoS flow and/or the one or more UEs.

63. The method of claim 59, wherein the traffic profile is received from one or more UEs via at least one of a Protocol Data Unit (PDU) session and an Internet Protocol (IP) connection.

64. The method of claim 59, wherein the method further comprises:
notifying the one or more UEs and/or the server of the determined changes to the connectivity of the one or more UEs to the RAN and/or changes to one or more QoS flows.

65. The method of claim 59, wherein the control signals are sent to any of:
a centralised unit (CU) in the RAN, one or more distributed units (DUs) in the RAN, or one or more base stations in the RAN.

66. The method of claim 59, wherein the changes to the connectivity of one or more UEs and/or changes to one or more QoS flows are determined in order to meet or satisfy the received traffic profile.

67. The method of claim 59, wherein the determined changes comprise any one or more of: moving a QoS flow to a different cell in the RAN; modifying a QoS flow; releasing a QoS flow; adding a QoS flow; moving a UE to a different cell in the RAN; releasing a UE that is connected to the RAN; and releasing or disconnecting a QoS flow or UE that has a lower priority than a QoS or UE associated with the received traffic profile.

68. The method of claim 59, wherein the step of determining changes comprises:
calculating a load metric for a first cell from measurements representing performance of the first cell;
comparing the calculated load metric to a target load metric for the first cell; and
determining whether the received traffic profile can be satisfied in the first cell based on the comparison.

69. The method of claim 68, wherein the first cell is a primary cell (PCell) and if it is determined that the received traffic profile cannot be satisfied in the PCell based on the comparison, determining whether the received traffic profile can be satisfied in a secondary cell (SCell).

70. The method of claim 68, wherein if it is determined that the received traffic profile cannot be satisfied in the first cell:
determining if one or more QoS flows and/or UEs connected to the first cell have a lower priority than traffic according to the received traffic profile; and
determining to move, modify or release one or more QoS flows or UEs connected to the first cell having a lower priority.

71. A radio access network (RAN) resource management node for managing resource usage in a RAN of a communication network, wherein one or more user equipments (UEs) are to communicate using the RAN, the RAN resource management node comprising a processor and a memory, said memory containing instructions executable by said processor whereby said RAN resource management node is operative to:
receive a traffic profile for traffic for the one or more UEs, wherein the traffic profile is received via application layer communications from a UE and/or a server that is connected to the communication network, wherein the traffic profile relates to requirements for one or more Quality of Service (QoS) flows for the one or more UEs;
monitor performance of one or more cells in the RAN;
determine, based on the monitored performance and the received traffic profile, changes to the connectivity of one or more UEs to the RAN and/or changes to one or more QoS flows; and
send control signals to the RAN to effect the determined changes.

72. The RAN resource management node of claim 71, wherein the received traffic profile relates to one or both of uplink traffic and downlink traffic.

73. The RAN resource management node of claim 71, wherein the received traffic profile indicates an importance and/or priority of traffic in one or more QoS flows and/or traffic for one or more UEs.

74. The RAN resource management node of claim 71, wherein the received traffic profile indicates an importance and/or priority of traffic in one or more QoS flows and/or traffic for one or more UEs relative to an importance and/or priority of traffic in one or more other QoS flows and/or traffic for one or more other UEs.

75. The RAN resource management node of claim 71, wherein the traffic profile relates to a subset of established QoS flows and/or a subset of the UEs connected to the RAN.

76. The RAN resource management node of claim 71, wherein the traffic profile indicates any one or more of:
a criticality of the traffic for the QoS flow and/or the one or more UEs;
an average data throughput on uplink and/or downlink for the traffic for the QoS flow and/or the one or more UEs;
a peak data throughput on uplink and/or downlink for the traffic for the QoS flow and/or the one or more UEs;
a periodicity type for the traffic for the QoS flow and/or the one or more UEs;
a transfer interval for the traffic for the QoS flow and/or the one or more UEs;
an inactivity period for the traffic for the QoS flow and/or the one or more UEs;
a jitter tolerance for the traffic for the QoS flow and/or the one or more UEs;
a packet loss tolerance for the traffic for the QoS flow and/or the one or more UEs; and
a typical packet data size for the traffic for the QoS flow and/or the one or more UEs.

77. The RAN resource management node of claim 71, wherein the traffic profile is received from one or more UEs via at least one of a Protocol Data Unit (PDU) session and an Internet Protocol (IP) connection.

78. The RAN resource management node of claim 71, wherein the RAN resource management node is further operative to:
notify the one or more UEs and/or the server of the determined changes to the connectivity of the one or more UEs to the RAN and/or changes to one or more QoS flows.

79. The RAN resource management node of claim 71, wherein the determined changes comprise any one or more of: moving a QoS flow to a different cell in the RAN; modifying a QoS flow; releasing a QoS flow; adding a QoS flow; moving a UE to a different cell in the RAN; releasing a UE that is connected to the RAN; and releasing or disconnecting a QoS flow or UE that has a lower priority than a QoS or UE associated with the received traffic profile.

80. The RAN resource management node of claim 71, wherein the RAN resource management node is operative to determine changes by:
calculating a load metric for a first cell from measurements representing performance of the first cell;
comparing the calculated load metric to a target load metric for the first cell; and
determining whether the received traffic profile can be satisfied in the first cell based on the comparison.
